(19) United States
(12) Patent Application Publication
(10) Pub. No.: US 2026/0349831 A1
(43) Pub. Date: Nov. 5, 2026

(54) SYSTEMS AND METHODS FOR CONTROLLED CHAINED EXECUTION OF SOFTWARE DEFINED AGENTS THROUGH DYNAMIC CONTROL PLANE CONFIGURATION

(71) Applicant: RingCentral, Inc., Belmont, CA (US)

(72) Inventors: Mostafa Tofighbakhsh, Cupertino, CA (US); Khurram Taji, San Jose, CA (US); Homayoun Razavi, Belmont, CA (US)

(73) Assignee: RingCentral, Inc., Belmont, CA (US)

(21) Appl. No.: 19/195,818

(22) Filed: May 1, 2025

(51) Int. Cl. G06F 9/50; G06N 5/043; H04L 9/40

(52) U.S. Cl. CPC G06F 9/5077; G06N 5/043; H04L 63/0428

(57) ABSTRACT

Disclosed is system and associated methods for autonomously creating an advanced artificial intelligence (AI) personal assistant through the controlled and distributed chained execution of a set of software-defined (SD) agents. The system controller receives an objective and partitions the objective into a set of tasks. The controller selects the SD agents to have a different Large Language Model (LLM) that is trained on different subject matter of one or more of the set of tasks. The controller establishes a control plane, configures the SD agents, and updates the configurations based on changes to the objective or the tasks that controller makes over time to optimize or improve the objective execution. The controller presents a final output in response to verifying that output produced by each SD agent satisfies different thresholds for advancing through the objective.

### TECHNICAL FIELD

The present disclosure relates to the fields of digital virtual assistants and artificial intelligence (AI). The digital virtual assistants and AI are associated with the related technical field of assistive automation.

### BACKGROUND

Virtual personal assistants, like Siri®, Cortana®, and Gemini^{TM}, are limited in their usefulness because of the type of tasks they are able to perform. The tasks involve a one-time executed action that provides an immediate response to a user query. For instance, a user may ask for the weather forecast or movie times, and the virtual personal assistant may perform a query to provide the most relevant answer. Accordingly, the virtual personal assistants are task-specific meaning that they execute the task they are given and provide an immediate result. The virtual personal assistants are not sophisticated enough to assume the role of a human assistant and continuously work on a set of tasks in order to fulfill a general objective or intent of the user over time.

There is a need for more advanced virtual personal assistants that are objective-based or intent-based and that run continuously to automatically determine, generate, and perform the tasks for an overarching objective or intent that may be unbounded, not have an end result, not produce an immediate result or answer, or require extended execution over hours, days, or months. To this end, there is a need to develop an advanced virtual personal assistant that partitions the overarching objective or intent into the set of tasks automatically without the user having to manually define each task of the set of tasks required to complete the overarching objective or intent. There is also a need for a control plane to manage and control the distributed and chained execution of the set of tasks by different virtual agents.

### BRIEF DESCRIPTION OF THE DRAWINGS

FIG. 1 illustrates an example of controlling the chained execution of software-defined (SD) agents through a dynamic control plane configuration in accordance with some embodiments presented herein.

FIG. 2 illustrates an example architecture for autonomously creating an advanced AI personal assistant via the controlled chained execution of SD agents through a dynamic control plane configuration in accordance with some embodiments presented herein.

FIG. 3 illustrates an example of initializing a controller for execution of a high-level objective in accordance with some embodiments presented herein.

FIG. 4 illustrates an example of performing the SD agent configuration and control via a control plane in accordance with some embodiments presented herein.

FIG. 5 presents a process for the dynamic control plane configuration of a set of SD agents collectively implementing a high-level objective in accordance with some embodiments presented herein.

FIG. 6 illustrates a specific example of implementing a high-level objective through the controlled chained execution of SD agents in accordance with some embodiments presented herein.

### DETAILED DESCRIPTION OF PREFERRED EMBODIMENTS

This disclosure arises from the realization that virtual personal assistants that execute on user devices are limited in the functionality that they provide due to each interaction being a one-time prompt-specific operation. While helpful in providing quick answers or executing a simple task in response to a voice command or other prompt, the virtual personal assistants fall short of replacing human agents and employees. Human agents or employees perform specialized roles for a business or an individual. The roles involve continuously determining and performing different tasks related to a general mandate that is given to the human agents or employees to carry out. The general mandate may correspond to an unbounded objective or an intent that the human agents or employees implement to the best of their abilities without being told what the individual tasks are to fulfill the objective or the intent.

The current disclosure provides a technical solution for a technological problem in the field of digital or virtual personal assistants and artificial intelligence (AI). The technical solution involves defining and providing a control plane for controlling the execution of different software-defined (SD) agents towards the partitioned and collective advancement of a high-level objective. An autonomous SD agent controller uses the control plane to dynamically and in real-time configure and reconfigure different SD agents to perform changing tasks until the set of tasks performed by the collective set of SD agents effectuates the high-level objective. The dynamic configuration and reconfiguration over the control plane allows the controller to control dynamic execution combinations of the SD agents and to adjust the SD agent execution in real-time in response to determining that a particular task executed by one of the SD agents does not advance the high-level objective or in response to failed execution of the particular task by an SD agent due to an improper or incomplete configuration of that SD agent.

The controller assumes the role of a human agent or employee by autonomously modeling, determining, and implementing the correct set of tasks that satisfy or complete the high-level objective without receiving an enumeration or definition of the tasks. For instance, the controller may monitor human agent actions and behaviors to generate models that associate or deconstruct a high-level objective into a set of tasks that different specialized SD agents perform and that collectively produce the result for the high-level objective. The controller may hide the outputs produced by various SD agents in order to present the relevant output for the high-level objective when the collective chained execution of the SD agents yields the relevant output. The controller may also leverage the control plane to link the SD agent to devices and systems that different SD agents may autonomously control in order to provide various human-to-machine interfaces. For instance, the controller may configure the SD agents to perform real-world interactions with humans by autonomously controlling different telephony, video meeting, access control (e.g., door locks), credit card and other payment terminals, point-of-sale, and/or other hardware that is remote or independent of the one or more devices or systems on which the controller executes. As the intent behind the objective becomes more refined through the task execution and/or as different advancements are made through the high-level objective, the controller may dynamically change the devices and/or systems that the SD agents control, reconfigure the operations that the SD agents perform, and/or otherwise modify the tasks in real-time to overcome unexpected use cases, stalled advancement of the high-level objective, and/or incorrect configurations that do not advance the high-level objective.

The control plane allows the controller to deploy and run the SD agents in a distributed fashion across cloud, edge, or local resources and/or across different autonomously controlled devices or systems. Accordingly, the technical solution is differentiable from prior art virtual personal assistants that execute a one-time action directly in response to a single query, run on a single device, and/or execute from a single AI model or virtual agent. The technical solution uses the controller to partition a high-level objective into multiple tasks, dynamically deploy and configure multiple specialized SD agents across different resources, devices, or systems to perform a different one of the tasks, control the chained execution of the specialized SD agents to advance different parts of the high-level objective, and generate the high-level objective output from the collective output of the SD agents.

The technical solution involves configuring the different SD agents to assume the specialized roles of different human agents so that, collectively, the different SD agents may perform a complex, non-deterministic, and/or continuous high-level objective that requires the subject matter expertise from each of the specialized roles. To this end, the technical solution involves configuring the SD agents with multiple different AI and Large Language Models (LLMs). The different AI and LLMs are trained to specialize in different subject matter and model specialized actions and decision-making for different use cases or scenarios associated with the trained subject matter. In some example embodiments, the SD agents may be configured to launch additional SD agents with different LLMs to resolve issues or parts of tasks that are out of scope of the executing SD agent.

In summary, the technical solution involves providing an advanced personalized virtual assistant via the controller, the control plane, and the SD agents. The advanced personalized virtual assistant effectuates a high-level objective that may be unbounded, runs continuously or over an extended period of time, does not have an end result, does not produce an immediate result or answer, requires external triggers or inputs, or is defined as a general mandate or user intent without an enumeration of the tasks for fulfilling that mandate or user intent.

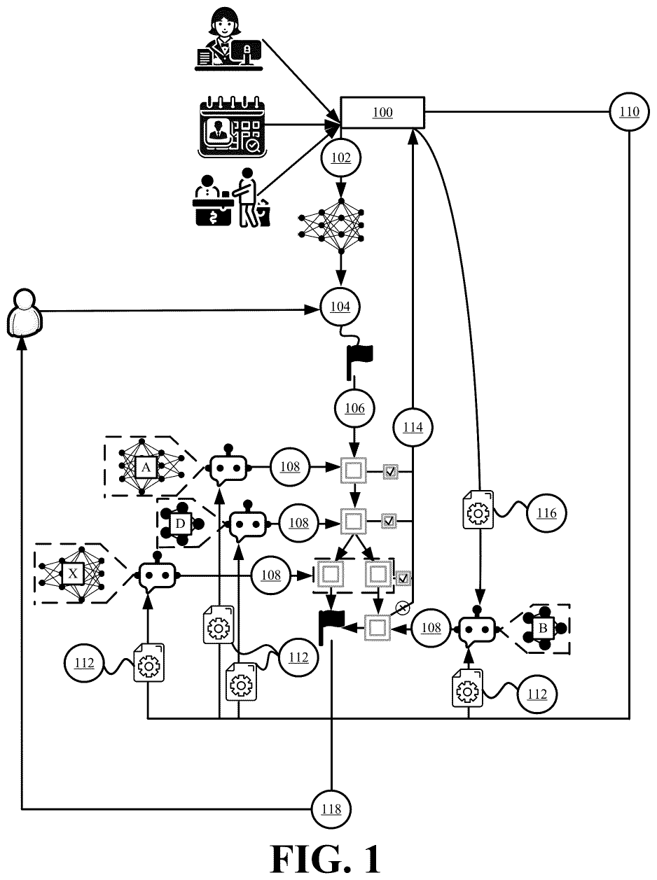

FIG. 1 illustrates an example of controlling the chained execution of SD agents through a dynamic control plane configuration in accordance with some embodiments presented herein. Controller 100 trains (at 102) one or more models for different tasks that are associated with different objectives of different businesses or entities. In some example embodiments, controller 100 trains (at 102) the one or more models by monitoring interactions and operations that are performed by human agents of the different businesses or entities, by associating the interactions and operations to different tasks, and by grouping a set of tasks to a high-level objective that may be associated with a role of an identified human agent. The training (at 102) may be supplemented by searching various databases, instructional guides, and/or external sources for sets of tasks that are associated with different high-level objectives. In some other example embodiments, controller 100 trains (at 102) the one or more models by compiling different sets of tasks through an iterative learning process in which tasks are defined to fulfill or satisfy different parts of a high-level objective, executed in a simulated environment using AI, and refined with modified or new tasks until the simulated outputs of the set of tasks satisfy different thresholds for advancing through that high-level objective.

Controller 100 receives (at 104) a high-level objective from a user or user device. The high-level objective may be provided as an audio recording, text, selections through a user interface, and/or other inputs that describe a user's intent for the high-level objective. In some example embodiments, controller 100 may use a speech-to-text transcription tool to transcribe a verbal statement of the high-level objective.

The high-level objective may be continuous, unbounded, and/or non-deterministic. The high-level objective may be defined as one or more overarching goals that are involve execution of multiple different tasks. However, the tasks are not defined or enumerated as part of the high-level objective statement or definition. For instance, the high-level objective may state greet and check-in new guests. The greeting and check-in objective may be different for different businesses and may involve multiple tasks such as detecting when a new guest arrives, verifying the appointment of the guest to determine the service provider that treats the guest, having the guest fill out an intake form, and/or notifying the correct service provider that their guest has arrived. Similarly, a high-level objective for check-out guests may involve multiple tasks such as detecting when a guest is departing, receiving a list of rendered services, determining the billing amount for each rendered service, determining whether insurance covers the billing amount, receiving payment from the departing guest, and/or scheduling a follow-up appointment with the departing guest.

Controller 100 partitions (at 106) the high-level objective into a set of tasks that produce outputs that collectively satisfy or complete the high-level objective. The partitioning (at 106) is performed by referencing the one or more models using the description of the high-level objective as input. Accordingly, controller 100 may use Natural Language Processing (NLP) or other artificial intelligence and/or machine learning (AI/ML) techniques to define and/or determine machine-executable steps or actions (e.g., tasks) that collectively effectuate, implement, or satisfy the high-level objective. In some example embodiments, each task of the set of tasks may include a set of actions that advance the high-level objective past different thresholds. In some other example embodiments, controller 100 uses an agentic AI, accessible private user data, and relevant public data to deductively reduce the high-level objective to the set of tasks.

Controller 100 selects (at 108) a set of SD agents from an available pool of SD agents based on the subject matter or specialty associated with each task of the partitioned (at 106) set of tasks. Each SD agent from the available pool of SD agents may execute and/or perform a specialized set of operations that are defined or generated according to a different Large Language Model (LLM). Each LLM of an SD agent may be trained on or specialized for the subject matter associated with one or more tasks of the set of tasks that are assigned to that SD agent. For instance, each LLM may be trained to understand and/or parse inputs associated with a given subject matter and to execute actions that resolve or generate the correct output for the inputs, tasks, or modeled use cases associated with that given subject matter. As a specific example, a first LLM may be trained to receive an inbound call and direct the caller to a second LLM based on the caller's requests or answers to questions posed by the first LLM for directing the call. The second LLM may be trained to schedule appointments for different services offered by a particular business by accessing and making correct changes to the calendars of the particular business employees.

Controller 100 establishes (at 110) a control plane for the selected (at 108) set of SD agents. The control plane is a secure communication channel by which controller 100 communicates, controls, and configures the execution of the set of SD agents. Additionally, the control plane is used to provide inputs and outputs between controller 100 and the set of SD agents and is used to maintain statistics and state on each SD agent of the set of SD agents. The control plane combines the functionality of controller 100 and the selected (at 108) set of SD agents into a single advanced AI personal assistant for performing the received (at 104) high-level objective without exposing the set of SD agents, their configurations, and/or their operations to the user.

Controller 100 configures (at 112) the chained execution of the set of SD agents using configuration files or matrices that controller 100 distributes to the set of SD agents over the control plane. Although the set of SD agents execute and/or perform a specialized set of operations via the associated SD agent LLM, those operations may be configured specifically to the received (at 104) high-level objective. For instance, a selected SD agent may be initialized with an LLM that provides telephony services and that generates conversational audio related to scheduling an appointment. The configuration matrices provide the telephone numbers that the selected SD agent is to contact, a list of services specific to a business that is associated with the high-level objective and that are scheduled for an appointment, and access to calendars of service providers providing one or more services from the list of services. The configuration matrices may further configure the set of operations that each SD agent performs. For instance, the configured set of operations may include specifying pricing or providing a description for any service from the list of services that a user selects. Alternatively, the configured set of operations may include adding operations to identify service providers that a user has used in the past and first suggesting an appointment with a previously used service provider before suggesting appointments with other service provider rather than suggesting a first available service provider.

In some example embodiments, the configuration matrices may specify a desired output or output format for each SD agent. The LLM of an SD agent adjusts its operations to produce the desired output or output format.

The configuration of the SD agents may also be affected by non-configuration data that is received over the control plane. The SD agents are connected to the control plane and may be configured to actively monitor messaging or data that is passed over the control plane. The control plane data may include inputs and/or outputs of other SD agents, updates to the high-level objective and/or assigned set of tasks made by controller 100 or other SD agents, data from autonomously controlled devices and/or systems, and/or data from external sources or sites. The SD agent LLMs may use the data received over the control plane to dynamically define the operations for completing or satisfying an assigned task. Accordingly, the control plane data may serve as additional configuration information that the SD agent LLMs use in combination with the configuration matrices.

In some example embodiments, the configuration matrices specify where the SD agents output is sent. For instance, the SD agents may be configured to send their respective outputs to controller 100 over the control plane for verification before being redirected to one or more SD agents. Alternatively, the SD agents may be configured to send their respective outputs directly to other SD agents over the control plane to create a dependency chain in which the outputs from some SD agents serve as inputs to other SD agents.

The configuration matrices may be defined with formulas, formula combinations, chained inferences, and/or other data for configuring the operation of a selected (at 108) SD agent. In some such example embodiments, the configuration matrices may be used to add, remove, or adjust inferences or pathways of the SD agent LLMs.

In some example embodiments, the configuration matrices specify the order of execution for the set of SD agents. In some such example embodiments, the configuration matrices may specify dependencies between the SD agents. For instance, the execution of some SD agents may be dependent on the output of other SD agents such that SD agents may be triggered to activate upon receiving the outputs of one or more other SD agents. The configuration matrices may configure two or more of the set of SD agents to run in parallel in order to provide complementary services or to perform unrelated tasks whose outputs may be combined or used as inputs for execution by another SD agent.

In some other example embodiments, controller 100 controls the chained execution or order of execution for the set of SD agents by activating the SD agents at different times or as they are needed. For instance, controller 100 may send an activation message to a first SD agent over the control plane at a first time and verify the output of the first SD agent before sending an activation message to a second SD agent over the control plane.

Controller 100 monitors (at 114) the chained execution of the set of SD agents across the control plane. Monitoring (at 114) the chained execution may include receiving outputs as they are generated by the executing SD agents, and verifying that the outputs advance the high-level objective by satisfying different thresholds associated with each of the partitioned tasks. In some example embodiments, the thresholds and may include a range of expected values, milestones, and/or other indicators for successful or unsuccessful completion of a task.

Controller 100 reconfigures (at 116) one or more of the set of SD agents that are unsuccessful in completing their assigned task or that generate output that does not satisfy the thresholds set for advancing the high-level objective past the assigned task. Reconfiguring (at 116) the one or more SD agents includes halting execution or operation of the one or more SD agents via a control message sent over the control plane, adjusting the configuration matrices of the one or more SD agents to resolve detected issues, distributing the adjusted configuration matrices to the one or more SD agents, and activating execution of the one or more SD agents according to the adjusted configuration matrices via additional control plane messaging (e.g., control messages).

The reconfiguring (at 116) of the SD agents during execution of the high-level objective allows controller 100 to dynamically and in real-time iterate through different configuration combinations and/or assigned tasks until the SD agents of the advanced AI personal assistant are able to successfully satisfy or complete the high-level objective. The dynamic and real-time reconfiguration (at 116) includes controller 100 halting the high-level objective execution at any part in the chained execution of the SD agents that fails to advance the high-level objective, and trying new configurations or task assignments until the issue is resolved and an iteration of the high-level objective is complete. In doing so, controller 100 adapts the high-level objective execution for different use cases, input patterns, or usage scenarios that may arise during different execution iterations of the high-level objective such that the advanced AI personal assistant is not limited to executing the initial set of partitioned tasks with the initial SD agent configurations. In other words, controller 100 continually modifies the implementation of the high-level objective in an unsupervised manner to accommodate use cases and scenarios that were not previously modeled using agentic AI and/or ML techniques.

In some example embodiments, the SD agents may dynamically reconfigure (at 116) without direction or instruction from controller 100. For instance, a SD agent may encounter an issue, unexpected use case, or input that cannot be handled or resolved by the SD agent LLM during execution of the SD agent assigned task. The SD agent may dynamically reconfigure (at 116) by initializing and/or launching one or more additional SD agents with different LLMs that are trained on the subject matter associated with the issue, the unexpected use case, or the input. In some example embodiments, controller 100 may configure the SD agent with permissions and/or functionality to initialize and/or launch the SD subagents, and the SD agent may invoke the same control plane messaging as controller 100 to initialize and/or launch the SD subagents to resolve the encountered issues without waiting for controller 100 to reconfigure that SD agent. In some such example embodiments, the SD agent becomes a new controller instance for the SD subagents that it creates. In other words, the SD agents operates as controller 100 for the SD subagents that it creates by configuring, activating, monitoring, and/or reconfiguring the SD subagents.

In some example embodiments, controller 100 reconfigures (at 116) one or more of the SD agents after successfully completing one or more iterations of the objective. In some such example embodiments, controller 100 continually updates the SD agent configurations to optimize or improve the objective execution. For instance, controller 100 may refine the set of tasks to eliminate operations or tasks that are not needed or are irrelevant to the objective execution, may refine the set of tasks or define new tasks to improve the execution of new use cases that are encountered during various iterations of the objective execution, and/or to improve the user experience by identifying and adjusting tasks that are associated with negative user feedback.

Controller 100 presents (at 118) a final output or output that satisfies or completes the high-level objective to the requesting user or user device. The final output is generated based on the individual outputs produced by each SD agent over the course of the chained execution. In some example embodiments, the final output is derived from the collective output generated by the set of SD agents. In some other example embodiments, the final output is derived from the output that is generated by the SD agent executing last in the chained execution. In any case, controller 100 does not present outputs from all or each of the SD agents as they generated or at the end of an execution iterations of the objective as those outputs may be unrelated, incomplete, or a partial response to the objective. In some example embodiments, controller 100 presents (at 118) the output when an event, condition, or trigger associated with the objective is met or at defined times or states. In some such example embodiments, controller 100 may continue the chained execution of the set of SD agents for an unbounded or nondeterministic objective. For instance, controller 100 may provide a daily report of rendered services to checked-in guests.

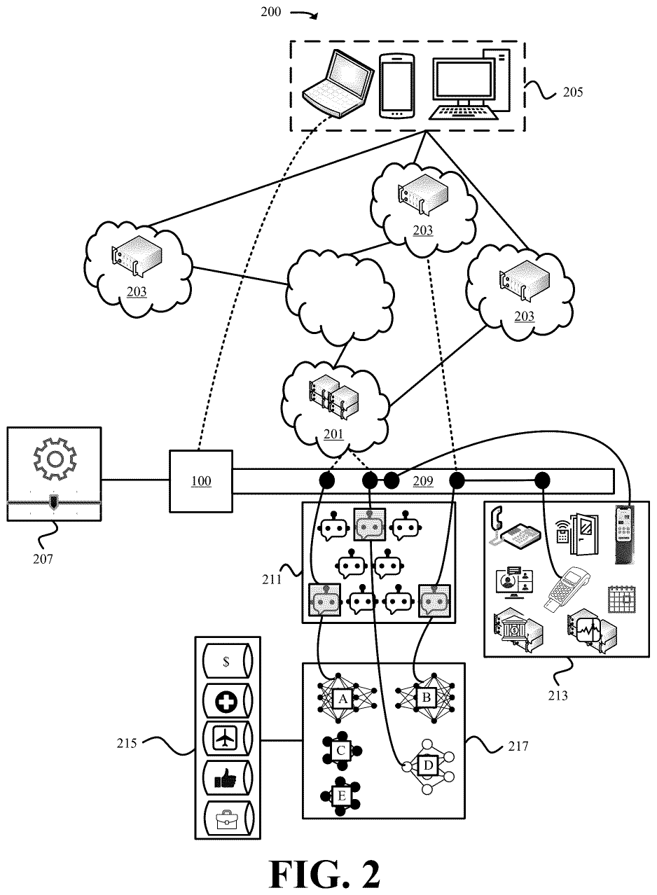

FIG. 2 illustrates an example architecture 200 for autonomously creating the advanced AI personal assistant via the controlled chained execution of SD agents through a dynamic control plane configuration in accordance with some embodiments presented herein. Example architecture 200 includes cloud resources 201, edge resources 203, local resources 205, controller 100, configuration portal 207, control plane 209, SD agents 211, autonomously controlled devices and systems 213, data stores 215, and LLMs 217. Different embodiments of example architecture 200 may include fewer, more, or combined resources and/or components. Accordingly, example architecture 200 is provided as one example embodiment for implementing the meshed execution of the user intent.

Controller 100 controls the deployment of SD agents 211 across cloud resources 201, edge resources 203, and/or local resources 205 via control plane 209. Each set of resources 201, 203, and 205 is associated with different latency, compute power, and/or cost. The devices or machines for cloud resources 201, edge resources 203, and local resources 205 include different processor, memory, storage, network, and/or other hardware resources that may be used to execute different instances of controller 100 and/or SD agents 211.

Cloud resources 201 include devices or machines of example architecture 200 that are remotely accessible over a data network with high latency (e.g., latency greater than 25 milliseconds). Cloud resources 201 may be used to execute tasks that are not latency sensitive or that do not require real-time responsiveness. Cloud resources 201 are scalable to support increasing numbers of executing SD agents 211.

Edge resources 203 include devices or machines of example architecture 200 that are located at different network points-of-presence (PoPs) next to different geographic regions in order to provide low latency communication (e.g., latency less than 25 milliseconds) to devices and systems (e.g., user devices or autonomously controlled devices and systems 213) in those different geographic regions. Controller 100 may determine that certain tasks are latency sensitive for certain regions and may deploy SD agents 211 that perform those tasks to edge resources 203 that are most proximate to those regions.

Local resources 205 include resources of a user device. The user device may be the device that the user uses to configure controller 100. The user device may include a device that the user carries on their person and/or interacts with at home or in a business setting. Controller 100 may deploy SD agents 211 to execute on local resources 205 for security and/or privacy reasons (e.g., prevent data from being exposed to external devices or systems). Moreover, SD agents 211 running on local resources 205 may provide the user with more timely responses or responses when there is no network connectivity as some parts or all of the high-level objective may be executed locally on the user device.

Controller 100 may be configured to run on cloud resources 201, edge resources 203, local resources 205, or any combination thereof. Configuration portal 207 in an interactive interface for configuring or creating different instances of controller 100 to fulfill different high-level objectives. For instance, a user may create a first controller 100 instance to execute financial planning objectives, and may create a second controller 100 instance to execute business objectives. A user device may access configuration portal 207 via a locally executing application or from a remote site.

Configuration portal 207 may be used to define a new instance of controller 100, provide a name by which the user may call or interact with that controller 100 instance, specify the high-level objective for the created controller 100, provide controller 100 access to sets of private and/or public data that are associated with the high-level objective or that are needed to effectuate the high-level objective, and/or otherwise configure controller 100. In some example embodiments, configuration portal 207 includes selectable fields, drag-and-drop functionality, and/or other interactive user interface (UI) elements for defining each controller 100 instance. In some other example embodiments, configuration portal 207 defines each controller 100 instance based on code or textual statements.

Controller 100 partitions its high-level objective into a set of tasks based on a prior modeling of the high-level objective. Specifically, the models used to partition the high-level objective are trained to provide relevant tasks for satisfying or completing different components of the high-level objective and/or for advancing the high-level objective from an initial state or current state to a desired final state. Controller 100 selects LLMs 217 that are specialized or trained for the subject matter associated with one or more tasks of the partitioned set of tasks, selects autonomously controlled devices and systems 213 that provide machine-to-human interfaces for certain tasks, and initializes SD agents 211 across cloud resources 201, edge resources 203, or local resources 205 based on the partitioned tasks, selected LLMs 217, selected autonomously controlled devices and systems 213, and/or performance, cost, and resource availability constraints.

Controller 100 controls the deployment, configuration, and execution of SD agents 211 via control plane 209. Control plane 209 may be a secure communication channel by which controller 100 and the deployed set of SD agents 211 communicate. Control plane 209 is associated with a communication protocol that includes command messages for deploying and initializing SD agents 211 on different resources, configuration messages for configuring or changing the configuration of SD agents 211, control messages for controlling the execution and/or activation of SD agents, and/or other messages for routing SD agent outputs to controller 100 or other SD agents 211.

Control plane 209 secures the communication and data that is exchanged by the distributed SD agents 211, autonomously controlled devices and systems 213, data stores 215, and LLMs 217 of a single advanced AI personal assistant. For instance, SD agents 211 of a particular advanced AD personal assistant created by controller 100 may run on different sets of resources 201, 203, and 205 and may access different autonomously controlled devices and systems 213. Control plane 209 defines which SD agents 211 may access which autonomously controlled devices and systems 213 and/or which SD agents 211 may interact or exchange data with other SD agents 211. Control plane 209 prevents other controllers 100, devices, or systems from communicating or controlling SD agents 211 of an advanced AI personal assistant that they did not create or initialize.

Control plane 209 creates a separation layer between the user-to-controller interface the complex controller-to-SD agent layer. The user-to-controller layer is where the user specifies their high-level objective and views the results of the high-level objective via direct communications with controller 100. The controller-to-SD agent layer is hidden from the user unless access is specifically requested by the user. The controller-to-SD agent layer may correspond to the control plane 209 messaging and is where controller 100 dynamically performs the chained execution of different tasks with the different specialized LLMs 217 of SD agents 211 to effectuate different parts of the high-level objective, verify that the executed tasks advance the high-level objective towards its goals, and reconfigure SD agents 211 when one or more tasks executed by one or more SD agents 211 fail to advance the high-level objective.

SD agents 211 may correspond to autonomous bots or virtual AI agents that execute different subject matter-specific actions. SD agents 211 may provide different machine-to-human interfaces for different aspects of the high-level objective by controlling one or more autonomously controlled devices and systems 213.

Autonomously controlled devices 213 may include telephony systems for receiving and placing audio calls, video meeting systems, credit card and other payment terminals, points-of-sale devices, video screens and/or speakers for greeting and interacting with humans, physical entry controllers (e.g., door locks and/or other mechanically controlled device of an access system), and/or other hardware. SD agents 211 may remotely operate autonomously controlled devices 213 to communicate or interact with humans or when the hardware is needed to execute one or more of the SD agent actions.

SD agents 211 may also execute actions using or through autonomously controlled systems 213. Autonomously controlled systems 213 may include a calendar system, a stock trading system, a banking system, an email system, a text messaging platform, a meeting system, and/or other systems that run on one or more hardware devices that are distinct and remote from the devices on which controller 100 and/or SD agents 211 execute. For instance, SD agent 211 may access a stock trading system on behalf of a user in order to execute trades (e.g., buy and sell stock) autonomously according to the high-level objective of the user. SD agents 211 may be granted access to control different user services and/or accounts running on different systems and platforms.

The user may interact with configuration portal 207 in order to configure and grant controller 100 and SD agents 211 access to autonomously controlled devices and systems 213. For instance, the user may enter the network address and access credentials by which a SD agent 211 may access and control an autonomously controlled device or system 213. Additionally, the user may link to the Application Programming Interface (API) of an autonomously controlled device or system 213, wherein the API includes the list of functions that may be called to cause the autonomously controlled device or system 213 to perform different actions.

Data stores 215 store the private user data and form the user's data lake. Each data store 215 may store a different set of private user data. For instance, a first data store 215 may store the user's financial transactions (e.g., purchase history, stock trades, bill payment, bank account balances, debt obligations, etc.) and a second data store 215 may store the user's health information (e.g., blood test results, prescribed medications, diagnostics, health history, etc.). The data within data stores 215 may be compiled and/or aggregated by providing controller 100 access to different user accounts or devices where the data may be siloed. The data in data stores 215 may also be obtained from tracking user activities (e.g., geolocation tracking) and/or actions that are performed on one or more user devices. In some example embodiments, the data in data stores 215 is populated by different running instances of controller 100 and/or SD agents 211.

The private user data stored in data stores 215 may be supplemented with public data that may be queried for and/or obtained from the web, social media sites, and/or publications that are accessible online. The private and public data may be used as inputs to determine the actions that are needed to effectuate the user intent and/or may be used to supplement the actions that are performed by virtual agents 211.

In some example embodiments, a user interfaces with configuration portal 207 to select or otherwise identify the data in data stores 215 that may be used to effectuate the high-level objective. In some other example embodiments, controller 100 is given access to data stores 215, and selectively queries data stores 215 based on the user-defined high-level objective.

LLMs 217 are neural networks or AI/ML models that are specifically trained on different subject matter. Each LLM 217 is trained to interpret, parse, and process queries, requests, and/or other inputs related to the specific subject matter that the LLM 217 is trained on and to generate correct, accurate, and/or expected output based on actions that are executed in response to the subject matter-specific input. For instance, a first LLM 217 may be trained to schedule appointments and a second LLM 217 may be trained to greet in-store customers. The training of the first LLM 217 may include providing a list of services that may be scheduled, semantically similar references for each service, an amount of time needed for each service, list of employees that provide each service, the availability or calendar of each employee, preferred employees for different customers, services provided to returning customers, service pricing, service frequency (e.g., the time frame between visits or requests for the same service), jargon or specific terminology related to the list of services, speech-to-text service to transcribe audio, and/or data that is specific for appointment scheduling. The first LLM 217 may be trained to generate words and/or audio to obtain necessary information for scheduling an appointment with a desired tone or behavior, to provide accurate information in response to questions about scheduling or the list of services, to enter appointments on the employee calendars or a business calendar, and/or to provide appointment notifications and confirmations. The training of the second LLM 217 may include providing a list of customer images, names, appointment times, and scheduled services, name pronunciations, desired tone for greetings, desired mannerisms for a virtual greeter, commonly asked questions and answers for a receptionist, jargon or specific terminology related to the list of services, and/or other data that is specific to a receptionist's role. The second LLM 217 may be trained to generate a personalized greeting upon recognizing a scheduled customer, complete questionnaires or information that may be required at the check-in time, notify the correct employee that their customer has arrived, and/or confirm information related to the scheduled appointment. Generating the personalized greeting may include creating a deepfake clone or visual representation of a receptionist, animating the visual representation, and generating audio that is synchronized with the movements and expressions of the visual representation.

SD agents 211 may be configured with one or more LLMs 217 in order to comprehend subject matter-specific requests or inputs and perform subject matter-specific actions. SD agents 211 may also be configured with access to one or more autonomously controlled devices and systems 213 in order to obtain inputs for the LLM, present the LLM generated content to a user, and/or perform the LLM generated actions.

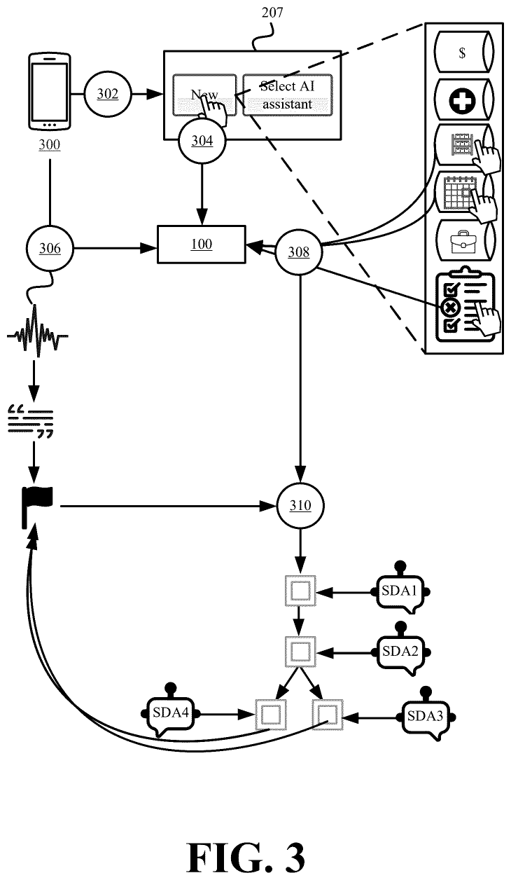

FIG. 3 illustrates an example of initializing controller 100 for execution of a high-level objective in accordance with some embodiments presented herein. User device 300 connects (at 302) to configuration portal 207. In some example embodiments, configuration portal 207 is accessed through an application that runs locally on user device 300. In some other example embodiments, configuration portal 207 is accessed at a remote site via a Uniform Resource Locator (URL), network address, or other link.

The user selects (at 304) an option on configuration portal 207 to create a new personalized virtual assistant. Selecting (at 304) the option to create the new personalized virtual assistant causes a new instance of controller 100 to be generated. The new instance may be given a name by which the user may reference or access controller 100.

The user provides (at 306) the high-level objective for the newly initialized controller 100. The high-level objective may be provided (at 306) as an audio prompt or as text.

The user may also define (at 308) rules or boundaries for the newly initialized controller 100. The rules or boundaries may include specific accounts and/or data sources that the newly initialized controller 100 has access to. The rules or boundaries may include restricting or enabling different actions that controller 100 may take or different functionality that controller 100 may execute (e.g., enable a subset of API calls, restrict image analysis tasks, etc.). The rules or boundaries may include business or regulatory policies, preferred business practices, regulations, guidelines, and/or other limits or restrictions on what the advanced AI personal assistance may access, process, and/or output. The rules or boundaries may be created by the user via configuration portal 207, selected from a list of rules or boundaries, or uploaded as part of a template.

Controller 100 analyzes the high-level objective and rules or boundaries to autonomously initialize and configure (at 310) SD agents 211. In particular, controller 100 generates different configuration files or matrices for each initialized SD agents 211 based on rules or boundaries that relate to the tasks that each SD agent 211 is initialized to perform.

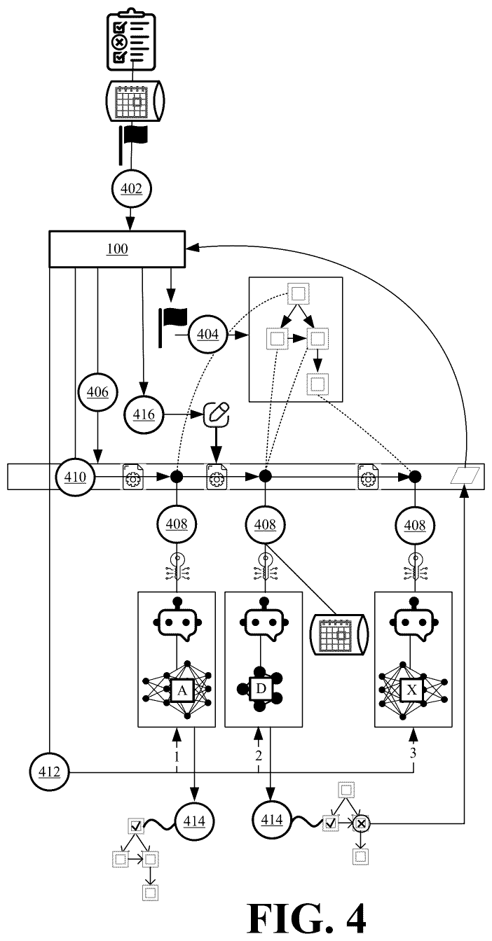

FIG. 4 illustrates an example of performing the SD agent configuration and control via the control plane in accordance with some embodiments presented herein. Controller 100 receives (at 402) a high-level objective with one or more rules or boundaries that restrict the data and/or actions by which controller 100 may effectuate the high-level objective.

Controller 100 determines (at 404) an initial set of tasks that are expected to satisfy or complete the high-level objective based on previous modeling of tasks that satisfy or complete the same or a similar high-level objective in a common field or industry. For instance, the high-level objective may include keywords for “medication”, “complications”, and “health”. Controller 100 enters these keywords into a model and the model identifies the tasks that were most commonly performed for other high-level objectives defined with the same or semantically similar terms.

The initial set of tasks may not be the final set that is executed to effectuate the high-level objective. Instead, the initial set of tasks are expected to be the tasks that have the highest likelihood of advancing the high-level objective to its ultimate goal with controller 100 having the ability to dynamically reconfigure the tasks while executing the initial set of tasks in response to one or more of the tasks failing to advance the high-level objective as expected or in response to a use case that was not accounted for in the modeling of high-level objective.

Controller 100 establishes (at 406) a control plane with which to initialize, configure, monitor, adjust, and/or activate different SD agents for the execution of the initial set of tasks. Establishing (at 406) the control plane may include creating a secure communication channel across which controller 100 and the different SD agents used to execute the initial set of tasks communicate.

Establishing (at 406) the control plane may include creating cryptographically secure tokens to identify each SD agent and/or controller 100 that is permitted access to the control plane and/or is part of the advanced AI personal assistant that is created to effectuate the received (at 402) high-level objective. Establishing (at 406) the control plane may include exchanging cryptographic keys that encrypt or secure the messaging passed between the different SD agents and controller 100. Accordingly, the control plane prevents outside interference from external SD agents, external controllers 100, external devices, or other systems. The control plane prevents the external SD agents, external controllers 100, external devices, or other systems from modifying configurations or operations of the SD agents that are initialized to execute the initial set of tasks and from communicating with any of the SD agents or controller 100.

Controller 100 initializes (at 408) a set of SD agents on the control plane. Initializing (at 408) the set of SD agents includes selecting SD agents with LLMs that are trained on the subject matter associated with one or more of the initial set of tasks. Specifically, the LLMs are specialized to process various inputs associated with the related subject matter and to produce outputs for different use cases or scenarios that are specific to the related subject matter based on the processing of the various inputs. Initializing (at 408) the set of SD agents may further include deploying the selected SD agents to run on available cloud, local, or edge resources, generating the secure tokens for uniquely identifying each SD agent under control of controller 100 on the control plane, generating cryptographic keys to allow communications between the set of SD agents and controller 100 on the control plane, and/or configuring the set of SD agents to accept command, configuration, and control messaging only from controller 100.

Controller 100 configures (at 410) each SD agent of the set of SD agents with a customized configuration matrix that is distributed over the control plane. The customized configuration matrix specifies the one or more tasks from the initial set of tasks that are assigned to a SD agent for execution. In some example embodiments, the customized configuration matrix includes formulas, formula combinations, chained inferences, and/or other operations or actions for the performing the assigned tasks. In some other example embodiments, the customized configuration matrix defines an output format, type of output, and/or desired output for the SD agent LLM to produce. For instance, the assigned task may include identifying complications between prescribed medicines and the desired output that is specified in the configuration matrix includes generating a listing of all complications with a score for the seriousness of the complication.

Controller 100 determines a chained execution ordering of the set of SD agents for effectuating the high-level objective. The chained execution ordering may be based on a sequential execution of each task from the initial set of tasks. Alternatively, the chained execution ordering may be based on dependencies between the outputs and inputs of different SD agents from the set of SD agents. For instance, an appointment cannot be scheduled until the guest is identified, the service that the guest requests is identified, and the guest availability is confirmed.

Controller 100 activates (at 412) execution of the set of SD agents according to the chained execution based on activation messaging that controller 100 sends over the control plane to specific SD agents at specific times. Activating (at 412) the execution of a particular SD agent may also include providing inputs, a query, or prompts to the particular SD agent. The inputs may include the output generated by one or more earlier activated (at 412) SD agents or human input obtained from an autonomously controlled devices and systems that the SD agent interface with. The query or prompts may be generated to define the task that the particular SD agent is to perform or specify the particular processing of a provided input.

Controller 100 verifies (at 414) the output that is generated by each activated (at 413) SD agent. In some example embodiments, the configuration matrix provided to each SD agent may configure the SD agent to send its output over the control plane to controller 100 for verification. Controller 100 verifies (at 414) the output to determine that it is in a correct format, within an expected set of values, and/or satisfies thresholds set for advancing the high-level objective past the assigned task. The thresholds may be defined for each task of the initial set of tasks as each task is generated. For instance, a high-level objective of taking over appointment calendaring for a business may include a task for gathering the appointment data from a user. The thresholds for advancing the high-level object past the appointment data gathering task may include verifying that the task output includes a full user name, user contact information in form of at least an email address or telephone number, a requested service, and optionally the name of a service provider.

In some example embodiments, an activated (at 412) SD agent may experience an error that prevents the output generation or is unable to generate output in a desired format or within an expected range of values. For instance, the SD agent may have an improper configuration, may receive inputs that it is not configured to process, or may be presented with a use case that has not been modeled otherwise accounted for in the configuration. In some such example embodiments, the SD agent may generate a control ticket or other error message to send to controller 100 over the control plane with or without the anomalous output. The control ticket may identify the processing errors encountered by the SD agent or the inputs that resulted in the processing errors. A control ticket may also be generated when the SD agent is not configured with the instructions or operations on executing specific parts of an assigned task.

Controller 100 reconfigures (at 416) a SD agent that produces output that fails verification (at 414) or that fails to advance the high-level objective past the assigned task. The control plane allows controller 100 to halt the execution of the high-level objective and/or tasks for effectuating the high-level objective at the position in the chained execution where the SD agent with the failed verification (at 414) is found.

Reconfiguring (at 416) the SD agent may include assigning a new or adjusted task to the SD agent to perform. The assignment of the new or adjusted task may be defined in an updated confirmation matrix that controller 100 sends to reconfigure (at 416) the SD agent operation. In some example embodiments, controller 100 analyzes the previous output that was generated by the SD agent for anomalous or incorrect values, determines inferences, formulas, and/or other parameters in the previous configuration matrix that affect the anomalous or incorrect values, and adjusts the inferences, formulas, and/or other parameters in the updated configuration matrix.

Controller 100 attempts different reconfigurations of the SD agent until the SD agent successfully completes its assigned task and advances its part of the high-level objective. Accordingly, controller 100 reconfigures (at 416) the SD agents as needed to modify the initial set of tasks into a modified set of tasks that adapt to unforeseen or unmodeled circumstances, use cases, or tasks. In other words, the controller 100 iterates through different sets of tasks via different SD agent configurations until the collective output from the SD agents satisfies or complete the high-level objective.

In some example embodiments, controller 100 reconfigures (at 416) the SD agents to expand the functionality or use cases. For instance, the high-level objective may be satisfied via execution of a modified set of tasks. However, a particular user interaction may cause the modified set of tasks to fail. In some such example embodiments, controller 100 reconfigures (at 416) the one or more SD agents that failed execution of their respective tasks in view of the particular user interaction to account for the new use case presented by the particular user interaction.

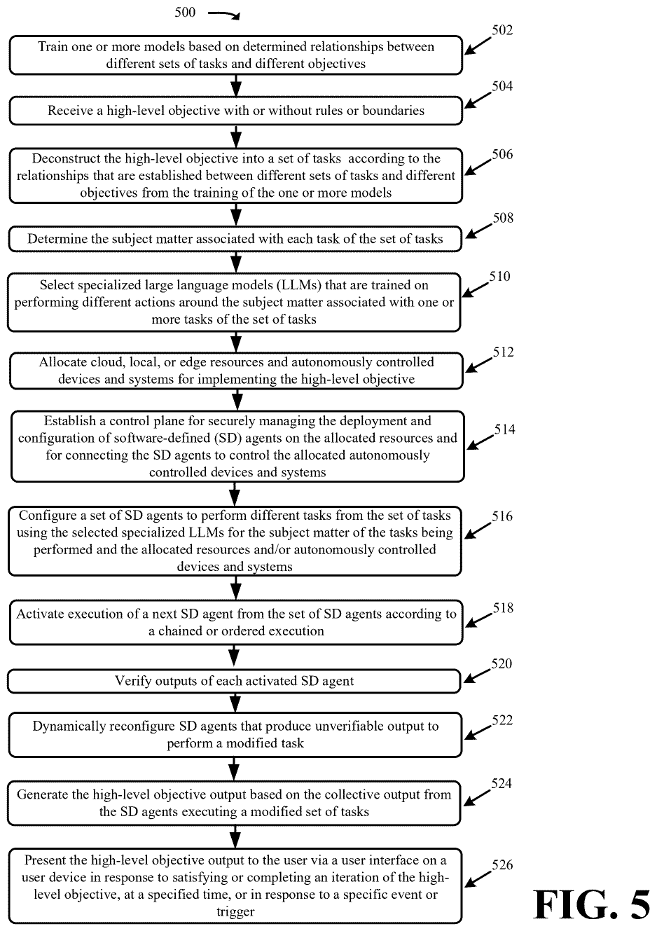

FIG. 5 presents a process 500 for the dynamic control plane configuration of a set of SD agents collectively implementing a high-level objective in accordance with some embodiments presented herein. Process 500 is implemented by controller 100 of a particular advanced personalized assistant.

Process 500 includes training (at 502) one or more models based on determined relationships between different sets of tasks and different objectives. The training (at 502) may include matching predefined or available tasks to operations or actions that are commonly, routinely, or frequently performed during execution of the different objectives. In some example embodiments, the one or more models are trained (at 502) by monitoring human agent operations or actions or by monitoring tasks that are repeatedly executed in combination with semantically similar keywords of different objectives. The monitoring may include analyzing email communications, text message communications, recorded audio meetings, and/or other forms of communication to detect the keywords associated with an objective, and tracking the tasks that are performed in order to satisfy the objective. Accordingly, controller 100 may use AI/ML techniques to model different roles of different human agents in order to effectively and autonomously replicate those roles in different sets of tasks and through the chained execution of multiple SD agents without human involvement. In some other example embodiments, the one or more models are trained (at 502) using iterative supervised or unsupervised AI/ML techniques that simulate the execution of different task combinations to identify a particular set of tasks that collectively produce output that satisfies or completes a related high-level objective with a highest degree of confidence or probability.

Process 500 includes receiving (at 504) a high-level objective with or without rules or boundaries for a new advanced AI personal assistant to perform. The high-level objective enumerates a user intent or desired outcome without enumerating the steps or tasks for achieving that user intent or desired outcome. In some example embodiments, the high-level objective is defined as an unbounded or non-deterministic goal or as a continuous role that is to be performed on behalf of the user. For instance, the high-level objective may include a statement to assume a receptionist role of checking-in arriving guests for one or more services and checking-out departing guests that have received one or more services. The rules or boundaries may specify the data sources or the autonomously controlled devices and systems that controller 100 has access to in order to perform the high-level objective. For instance, the rules and boundaries may provide controller 100 with access to appointment calendars, a service list that details available services, their descriptions, and their pricing, a point-of-sale device for processing transactions, and a virtual receptionist kiosk with a camera for detecting and interacting with the checking-in and checking-out guests. The rules and boundaries may also include best practices, terms of service, business policies, regulation, and/or requirement that the advanced AI personal assistant must adhere in the performance of the high-level objective.

Process 500 includes deconstructing (at 506) the high-level objective into a set of tasks according to the relationships that are established between different sets of tasks and different objectives from the training (at 502) of the one or more models. For instance, the modeled relationships may link different tasks to different keywords of the high-level objective. Accordingly, controller 100 generates the set of tasks automatically so that the implementation details may be omitted from the user's definition of the high-level objective.

Each task of the set of tasks may be defined as a set of actions or operations. Some actions or operations may involve human inputs or human interactions that are acquired using one or more autonomously controlled devices and systems. For instance, an action associated with a task may include detecting an arriving or departing guest. The detection requires a camera or other sensor at a point of ingress or egress or at a receptionist location. In some example embodiments, the actions or operations may be defined as instructions or code that an SD agent may directly execute. In some other example embodiments, the actions or operations may be defined as steps that an LLM of an SD agent converts into machine-executed instructions. For instance, a task for checking-in a guest may include the following actions: 1) detect guest arrival, 2) greet the guest, 3) obtain guest information, 4) lookup guest appointment, 5) confirm a scheduled service with the guest, 6) obtain missing information for the scheduled service from the guest, and 7) notify a human service provider associated with the scheduled service of the guest's arrival. A SD agent with a specialized LLM trained on greeting guests connects to the appropriate autonomously controlled devices and systems for detecting the guest arrival and/or for interacting with the guest via a virtual receptionist or message instructions.

Process 500 includes determining (at 508) subject matter associated with each task of the set of tasks. Each task may be associated with one or more subject matter where the subject matter may include the task topic, the general actions associated with the task, and/or a task classification. For instance, the task subject matter may include greeting, appointment scheduling, billing, personnel notification, guest detection, and the like.

Process 500 includes selecting (at 510) specialized LLMs that are trained on performing different actions around the subject matter associated with one or more tasks of the set of tasks. The specialized LLMs are trained to perform a variety of actions for different use cases or scenarios around the determined (at 508) subject matter. For instance, an LLM may be trained to perform the role of checking-in guests by modeling the different use cases or scenarios that may arise during check-in and by modeling best-practices and/or responses for each use case or scenario. As a specific example, a checking-in guest may request to change their scheduled service once they arrive, and the LLM may be trained to determine if there is availability for the changed service at the appointment time and/or to change billing so that the guest is charged for the changed service rather than the scheduled service.

Process 500 includes allocating (at 512) cloud, local, or edge resources and autonomously controlled devices and systems for implementing the high-level objective. The allocation (at 512) may include reserving the resources based on latency sensitivity associated with the set of tasks and/or access to autonomously controlled devices and systems for human-to-machine interfaces needed to satisfy or complete the high-level objective.

Process 500 includes establishing (at 514) a control plane for securely managing the deployment and configuration of SD agents on the allocated (at 512) resources and for connecting the SD agents to control the allocated (at 512) autonomously controlled devices and systems. The control plane is a secure or encrypted communication interface by which controller 100 controls the SD agents and prevents external access or viewing of the high-level objective data and/or data exchanged between controller 100 and the SD agents.

Establishing (at 514) the control plane may include generating secure tokens for identifying the SD agents and/or autonomously controlled devices and systems that are permitted to communicate over the control plane and/or execute different tasks of the set of tasks. Establishing (at 514) the control plane may further include negotiating cryptographic keys for securing communications of controller 100, the SD agents, and/or autonomously controlled devices and systems selected to execute the set of tasks and/or effectuate the high-level objective.

Process 500 includes configuring (at 516) a set of SD agents to perform different tasks from the set of tasks using the selected (at 510) specialized LLMs for the subject matter of the tasks being performed and the allocated (at 512) resources and/or autonomously controlled devices and systems. The configuration (at 516) is performed over the control plane. The configuration (at 516) for each SD agent is defined in a different configuration matrix that controller 100 generates and distributes to one of the SD agents. The configuration matrix specifies the one or more tasks that are assigned to a SD agent for execution, the one or more specialized LLMs to use in processing inputs and in generating outputs, expected or correct outputs for the assigned one or more tasks, tokens and/or cryptographic keys for secure communications over the control plane, interfaces by which the SD agent may access one or more of the allocated (at 512) autonomously controlled devices and systems, and/or execution ordering or chaining that specifies when the SD agent is to execute, where the SD agent receives inputs from (e.g., another SD agent, controller 100, certain autonomously controlled devices and systems, etc.), and/or where the SD agent sends its output (e.g., to another SD agent at a specific network address, controller 100, etc.).

Process 500 includes activating (at 518) execution of a next SD agent from the set of SD agent the set of SD agents according to a chained or ordered execution that controller 100 controls. Controller 100 may send activation messages over the control plane to a next SD agent in the execution chain or order to cause that SD agent to commence execution of its assigned task according to the SD agent configuration. Controller 100 may provide input data with the activation messages. The input data may include outputs produced by a SD agent that executes earlier in the execution chain or order, inputs or data that is obtained from one or more autonomously controlled devices and systems, and/or data from accessible databases or other data sources. Controller 100 may also configure (at 516) the SD agents to send their outputs back to controller 100 for verification.

Process 500 includes verifying (at 520) outputs of each activated (at 518) SD agent prior to activating (at 518) a next SD agent in the execution chain or order. Controller 100 verifies (at 520) the outputs to ensure that the SD agents are properly configured, correctly execute their assigned tasks, and that the SD agents are correctly advancing the high-level objective. Controller 100 verifies (at 520) the SD agent output by comparing the output against thresholds that controller 100 defines for the task assigned to that SD agent. The thresholds may correspond to expected outputs or outputs that indicate that a task was successfully completed. For instance, an appointment scheduling task is successful when an appointment in a correct format (e.g., name of guest, schedule service, appointment time is within business hours and personnel for the requested service are available, etc.) is entered into one or more business calendars and is unsuccessful when an appointment cannot be created because input from a user could not be correctly handled by the specialized LLM of the SD agent.

Process 500 includes dynamically reconfiguring (at 522) SD agents that produce unverifiable output to perform a modified task. The dynamic reconfiguration (at 522) includes adjusting one or more parameters of the SD agent configuration matrix. The adjustments may include additional definition or restrictions on the task that the SD agent executes to prevent certain error causing scenarios or to expand functionality to resolve the error causing scenarios. The adjustments may include modifying the inputs that are provided to the SD agents to supply the SD agent with additional data that may be needed to resolve the error causing scenario. The adjustments may include introducing new formulas, inferences, or execution flows for new use cases.

In some example embodiments, the dynamic reconfiguration (at 522) occurs in real-time as each issue is detected or output that cannot be verified is received. In some such example embodiments, controller 100 halts the execution of subsequent tasks in the chain, and reexecutes the current task that failed with the updated configuration until the output for the current task can be verified (at 520). In other words, controller 100 continually adjusts the set of tasks and the SD agent configurations until a modified set of tasks are correctly executed by the SD agents according to their configurations to produce a collective output that satisfies or completes the high-level objective.

Process 500 includes generating (at 524) the high-level objective output based on the collective output from the SD agents executing a modified set of tasks and in response to the output from each task being verified to advance the high-level objective. The high-level objective output may be sourced or pieced together from outputs of two or more different SD agents or the output produced by a last SD agent in the execution chain or order.

Process 500 includes presenting (at 526) the high-level objective output to the user via a user interface on a user device in response to satisfying or completing an iteration of the high-level objective, at a specified time, or in response to a specific event or trigger specified as part of the high-level objective. For instance, the user may define the high-level objective to present output when an error is encountered, on a daily basis, or whenever a guest is billed.

Controller 100 may continually perform process 500 for an unbounded or continuous objective. For instance, process 500 may be repeated for every new guest or user that is detected, when a new triggering event occurs or is detected, or on a scheduled basis. Process 500 may include reconfiguring the SD agents after each iteration based on statistics or state that controller 100 obtains from monitoring the SD agents. Controller 100 may reconfigure the SD agents to optimize or improve the execution of the objective. Specifically, controller 100 may continually refine the set of tasks that are assigned to the SD agents and/or the SD agent configurations to eliminate extraneous operations or to eliminate tasks for use cases that were modeled for the objective but do not occur during the objective execution. Controller 100 may also refine the set of tasks and the SD agent configurations in response to updates to the objective that the originating user makes or that controller 100 autonomously detects from different executed iterations of the objective.

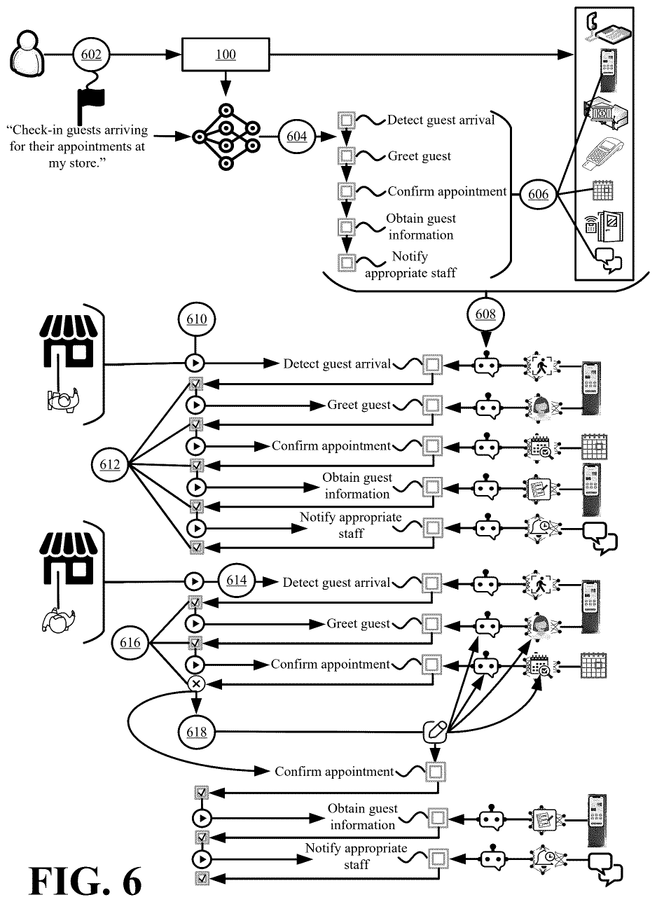

FIG. 6 illustrates a specific example of implementing a high-level objective through the controlled chained execution of SD agents in accordance with some embodiments presented herein. Controller 100 receives (at 602) the high-level objective for checking-in guests that arrive for their appointments.

Controller 100 determines (at 604) that the high-level objective and/or different keywords of the high-level objective are modeled with an association to a set of tasks including detecting guest arrival, guest greeting, appointment confirmation, obtaining guest information, and staff notification. Controller 100 further determines (at 606) that one or more of the tasks require access to a virtual receptionist kiosk at the merchant site, an appointment or calendaring system, and a telephony or messaging system.

Controller 100 configures (at 608) a set of SD agents to each perform a different task associated with the high-level objective. As part of configuring (at 608) the set of SD agents, controller 100 grants a subset of the set of SD agents access to control one or more of the virtual receptionist kiosk, the appointment or calendaring system, and the telephony or messaging system.

Controller 100 activates (at 610) the chained controlled execution of the set of SD agents such that a first SD agent performs the guest arrival detection, a second SD agent performs the guest greeting after the first SD agent successfully performs the guest arrival detection, a third SD agent performs the appointment confirmation after the second SD agent successfully performs the guest greeting, a fourth SD agent performs the guest information retrieval after the third SD agent successfully performs the appointment confirmation, and a fifth SD agent performs the staff notification after the fourth SD agent successfully performs the guest information retrieval.

Controller 100 verifies (at 612) the outputs of each activated (at 610) SD agent for a first guest. In other words, the first guest was checked-in in conformance with the high-level objective through the chained execution of the defined set of tasks by the SD agents.

Controller 100 performs additional iterations of the high-level objective by continuing the execution of the SD agents. For instance, controller 100 continually activates the first SD agent to detect (at 614) when a second guest arrives. In response to detecting the second guest arrival, controller 100 activates the other SD agents according to the chained execution flow.

Controller 100 verifies (at 616) the outputs of each activated SD agent for a second guest through the continued execution of the high-level objective via the SD agents performing the set of tasks. Controller 100 determines that the output produced by the third SD agent cannot be verified as the guest name by the second SD agent does not match any names in the appointment or calendaring system. Accordingly, controller 100 reconfigures (at 618) the second SD agent to obtain additional identifying information for the guest including a telephone number and/or email address that may be used to lookup the appointment that may have been made under a different name. Additionally, controller 100 may reconfigure (at 618) the third SD agent for walk-in guests that do not have previously scheduled appointments such that the third SD agent schedules a walk-in appointment and/or to schedules an appointment for a future time. Controller 100 may reconfigure (at 618) second and/or third SD agents multiple times until the outputs generated by the second and third SD agents for the second guest are verified and advance the high-level objective past thresholds set for greeting the guest and confirming the greeted guest's appointment or the greet guest for a walk-in appointment.

The embodiments presented above are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the above descriptions are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (“IoT”) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (“RAM”), read only memory (“ROM”), electrically erasable programmable ROM (“EEPROM”), flash memory, or other memory technology, compact disk ROM (“CD-ROM”), digital versatile disks (“DVDs”) or other optical storage, solid state drives, hard drives, hybrid drive, or any other medium that can be used to store the desired information and that can be accessed to retrieve that information.

It is appreciated that the presented systems and methods can be implemented in a variety of architectures and configurations. For example, the systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments. It should be understood, that terms “user” and “participant” have equal meaning in the following description.

1. A computer-implemented method for dynamic configuration of a plurality of software-defined (SD) agents collectively executing as a virtual personal assistant, the computer-implemented method comprising:
receiving an objective at a controller;
partitioning the objective into a set of tasks, wherein each task of the set of tasks effectuates a different part of the objective;
selecting the plurality of SD agents based on each SD agent of the plurality of SD agents comprising a different Large Language Model (LLM) that is trained on different subject matter of one or more tasks from the set of tasks;
establishing a control plane by which the controller controls operation of the plurality of SD agents;
configuring the plurality of SD agents with different configurations that the controller distributes to each SD agent of the plurality of SD agents over the control plane, wherein configuring the plurality of SD agents comprises:
modifying operations that the different LLM of a particular SD agent from the plurality of SD agents performs; and
defining an output that the LLM of the particular SD agent generates; and
presenting a final output from the controller in response to the controller verifying that output produced by each SD agent of the plurality of SD agents satisfies different thresholds for advancing through the objective, wherein the final output is generated from a collective output of the plurality of SD agents.

2. The computer-implemented method of claim 1, further comprising:
defining an ordered execution of the plurality of SD agents; and
activating the plurality of SD agents at different times based on the controller issuing activation messages according to the ordered execution.

3. The computer-implemented method of claim 1, further comprising:
monitoring different sets of tasks performed by different human agents in completing different objectives;
training a model to associate the different sets of tasks to the different objectives based on relationships detected during said monitoring; and
wherein partitioning the objective comprises determining that the set of tasks are associated with one or more keywords of the objective in the model.

4. The computer-implemented method of claim 1, wherein receiving the objective comprises:
receiving an audio prompt or a textual message that states the objective without referencing the set of tasks to effectuate the objective.

5. The computer-implemented method of claim 1, further comprising:
activating execution of a first task of the set of tasks by a first SD agent of the plurality of SD agents based on messaging passed by the controller to the first SD agent over the control plane;
receiving output of the first SD agent at the controller;
verifying that the output advances a first part of the objective at the controller; and
activating execution of a second task of the set of tasks by a second SD agent of the plurality of SD agents in response to verifying that the output advances the first part of the objective.

6. The computer-implemented method of claim 5, wherein verifying the output comprises:
comparing the output against a first threshold that is defined for the first task; and
determining that the output satisfies the first threshold.

7. The computer-implemented method of claim 1, further comprising:
determining an order of execution for the set of tasks that satisfies the objective;
activating execution of a particular task of the set of tasks by a particular SD agent of the plurality of SD agents according to the order of execution;
receiving output generated by the particular SD agent at the controller;
determining that the output does not satisfy or complete the particular task;
reconfiguring the particular SD agent in response to determining that the output does not satisfy or complete the particular task;
activating the particular SD agent to execute the particular task with a modified configuration; and
activating a next SD agent executing a next task in the set of tasks in response to output generated by the particular SD agent with the modified configuration satisfying or completing the particular task.

8. The computer-implemented method of claim 7, wherein reconfiguring the particular SD agent comprises:
redefining the particular task based on updates that the controller makes to the objective.

9. The computer-implemented method of claim 1, further comprising:
monitoring a chained execution of the set of tasks by the plurality of SD agents with the controller;
halting the chained execution at a particular task of the set of tasks in response to output generated by a particular SD agent of the plurality of SD agents executing the particular task not advancing the objective;
executing the particular task with one or more modified configurations of the particular SD agent; and
resuming the chained execution with a next SD agent of the plurality of SD agents in response to output generated by the particular SD agent with the one or more modified configurations advancing the objective.

10. The computer-implemented method of claim 1, wherein establishing the control plane comprises:
generating secure tokens that identify the controller and the plurality of SD agents on the control plane as components of the virtual personal assistant, wherein the controller and the plurality of SD agents discard messaging exchanging on the control plane without one of the secure tokens.

11. The computer-implemented method of claim 1, wherein establishing the control plane comprises:
generating cryptographic keys for encrypting messaging exchanged on the control plane by the controller and the plurality of SD agents.

12. The computer-implemented method of claim 1, further comprising:
determining that a particular task of the set of tasks involves receiving human input from a human-to-machine interface;
linking a particular SD agent from the plurality of SD agents that is assigned the particular task to an autonomously controlled device or system that provides the human-to-machine interface; and
controlling the autonomously controlled device or system with the particular SD agent in response to executing the particular task with the particular SD agent.

13. The computer-implemented method of claim 1, further comprising:
allocating the plurality of SD agents to run from different cloud, edge, and local resources; and
controlling a distributed chained execution of the plurality of SD agents across the different cloud, edge, and local resources based on control messaging passed by the controller over the control plane.

14. A controller for dynamically configuring a plurality of software-defined (SD) agents that collectively execute as a virtual personal assistant system, the controller comprising:
one or more hardware processors configured to:
receive an objective;
partition the objective into a set of tasks, wherein each task of the set of tasks effectuates a different part of the objective;
select the plurality of SD agents based on each SD agent of the plurality of SD agents comprising a different Large Language Model (LLM) that is trained on different subject matter of one or more tasks from the set of tasks;
establish a control plane by which the controller controls operation of the plurality of SD agents;
configure the plurality of SD agents with different configurations that the controller distributes to each SD agent of the plurality of SD agents over the control plane, wherein configuring the plurality of SD agents comprises:
modifying operations that the different LLM of a particular SD agent from the plurality of SD agents performs; and
defining an output that the LLM of the particular SD agent generates; and
present a final output from the controller in response to the controller verifying that output produced by each SD agent of the plurality of SD agents satisfies different thresholds for advancing through the objective, wherein the final output is generated from a collective output of the plurality of SD agents.

15. The controller of claim 14, wherein the one or more hardware processors are further configured to:
define an ordered execution of the plurality of SD agents; and
activate the plurality of SD agents at different times based on the controller issuing activation messages according to the ordered execution.

16. The controller of claim 14, wherein the one or more hardware processors are further configured to:
monitor different sets of tasks performed by different human agents in completing different objectives;
train a model to associate the different sets of tasks to the different objectives based on relationships detected during said monitoring; and
wherein partitioning the objective comprises determining that the set of tasks are associated with one or more keywords of the objective in the model.

17. The controller of claim 14, wherein receiving the objective comprises:
receiving an audio prompt or a textual message that states the objective without referencing the set of tasks to effectuate the objective.

18. The controller of claim 14, wherein the one or more hardware processors are further configured to:
activate execution of a first task of the set of tasks by a first SD agent of the plurality of SD agents based on messaging passed by the controller to the first SD agent over the control plane;
receive output of the first SD agent at the controller;
verify that the output advances a first part of the objective at the controller; and
activate execution of a second task of the set of tasks by a second SD agent of the plurality of SD agents in response to verifying that the output advances the first part of the objective.

19. The controller of claim 18, wherein verifying the output comprises:
comparing the output against a first threshold that is defined for the first task; and
determining that the output satisfies the first threshold.

20. A non-transitory computer-readable medium storing program instructions that, when executed by one or more hardware processors of a system for dynamic configuration of a plurality of software-defined (SD) agents collectively executing as a virtual personal assistant, cause the system to perform operations comprising:
receiving an objective at a controller;
partitioning the objective into a set of tasks, wherein each task of the set of tasks effectuates a different part of the objective;
selecting the plurality of SD agents based on each SD agent of the plurality of SD agents comprising a different Large Language Model (LLM) that is trained on different subject matter of one or more tasks from the set of tasks;
establishing a control plane by which the controller controls operation of the plurality of SD agents;
configuring the plurality of SD agents with different configurations that the controller distributes to each SD agent of the plurality of SD agents over the control plane, wherein configuring the plurality of SD agents comprises:
modifying operations that the different LLM of a particular SD agent from the plurality of SD agents performs; and
defining an output that the LLM of the particular SD agent generates; and
presenting a final output from the controller in response to the controller verifying that output produced by each SD agent of the plurality of SD agents satisfies different thresholds for advancing through the objective, wherein the final output is generated from a collective output of the plurality of SD agents.
